(19) United States
(12) Patent Application Publication
(10) Pub. No.: US 2004/0237547 A1
(43) Pub. Date: Dec. 2, 2004

(54) Method and installation for predicting the temperature of articles passing through a cooling chamber

(76) Inventors: Bernard Delpuech, Mauperas (FR); Pascal Favier, Meylan (FR); Sylvain Fourage, Issy Les Moulineaux (FR)

Correspondence Address: Air Liquide, Intellectual Property Department, 2700 Post Oak Blvd, Suite 1800, Houston, TX, 77056, US

(21) Appl. No.: 10/491,979

(22) PCT Filed: Oct. 3, 2002
(86) PCT No.: PCT/FR02/03371

(30) Foreign Application Priority Data
Oct. 5, 2001 (FR) 01/12860

(51) Int. Cl. F25B 49/00; G01K 13/00; F25D 17/00

(52) U.S. Cl. 62/126; 62/180; 62/129

(57) ABSTRACT

The invention relates to a method of predicting the temperature of articles (P) passing through the chamber (2) of a cooling installation using a coolant (4), said method comprising a step whereby the temperature of articles (P) exiting said chamber (2) is predicted. Said prediction is calculated from the characteristic quantities in relation to the operation of said chamber (2), the thermodynamic and physical characteristics of said chamber (2) and the thermodynamic and physical characteristics of said articles (P). The invention is suitable for controlling quick-freezing tunnels for food.

The present invention relates to a method of predicting the temperature of articles undergoing thermal cooling.

The invention applies for example to installations for the quick-freezing of food articles.

Known installations for quick-freezing comprise, for example, a quick-freezing chamber or tunnel traversed from one end to the other by a belt conveyor on which the articles to be frozen are deposited, the conveyor passing continuously or sequentially through the quick-freezing tunnel.

A cryogenic tunnel uses a low-temperature inert fluid which exchanges heat directly by contact with the products to be quick-frozen.

Conventionally, a cryogenic tunnel uses either dry ice (−80° C.) or liquid air, or liquid nitrogen (−196° C.) as cold vector. Dry ice allows fresh or quick-frozen products to be transported without fear of breaking the cold chain. Nitrogen and liquid air allow either individualized quick-freezing of food products, or the hardening of fragile, deformable or sticky products (such as dairy ice cream, etc.)

If the system consisting of the tunnel and the product load is examined, several parameters may influence the temperature of the product on exit: the production rate which, for a given degree of loading, implies a variation in the residence time in the chamber, the flow rate of the fluid which acts on the temperature profile, the entry temperature of the product, the convective profile of the chamber, and the degree of loading.

The system is therefore a multivariable system and a method of cooling cannot take these elements into account in a simple feedback loop.

The main difficulty in correcting the deviations from preset is related to the fact that there are at present no sensors on the market capable of continuously measuring the internal temperature of products without contact.

In the methods of prediction of the state of the art, in order to process monovariable systems, the convective profile and the degree of loading have had to be regarded as constants, and the production rate, the temperature of the products on entry to the quick-freezing chamber and the other operating parameters of the installations have had to be fixed.

One then alters for example the flow rate of the cryogenic fluid in order to define the mean profile of the temperatures of the fluid in the tunnel and thus to adjust the temperature of the product on exit.

The operational conditions and regulating presets are defined in recipes created experimentally. A recipe memorizes the tunnel adjustment parameters for a given production.

Should the production conditions vary, the operator has only very little latitude to modify the parameters, he can only load a new recipe.

An existing system described in French patent FR-A-2 760 272 implements a method allowing the prediction of the temperature of articles on exit from the chamber.

However, this prediction is based on a value representative of the amount of articles processed and on the amount of cryogenic fluid in whose presence the articles are placed. Such a prediction is therefore very approximate.

It is apparent that the existing methods exhibit a certain instability to operation, considerable difficulties of adjustment and a weak ability to adapt to the operating conditions.

The present invention is aimed at remedying these problems.

For this purpose, its subject is a method of predicting the temperature of articles passing from an entrance to an exit through a chamber of a cooling installation which uses a cooling fluid, which method comprises a step of predicting the temperature of articles on exit from said chamber, characterized in that said prediction is calculated on the basis of quantities characteristic of the operation of said chamber, of thermodynamic and physical characteristics of said chamber and of thermodynamic and physical characteristics of said articles.

According to other characteristics:

at least part of said quantities characteristic of the operation of said installation is input manually;

at least part of said quantities characteristic of the operation of said installation is charted automatically;

at least thermodynamic characteristics of said cooling fluid and said thermodynamic and physical characteristics of said chamber are used to perform a prediction of the behavior of said chamber based on the solving of heat balances on elementary slices of the volume of said chamber;

said prediction of the behavior of said chamber furthermore uses said quantities characteristic of the operation of said installation;

said quantities characteristic of the operation of said installation represent at least one of the elements chosen from the group consisting of:

the speed of a conveyor for transporting said articles through said chamber;

the degree of loading; and

the ventilation of the atmosphere of said chamber;

said prediction of the behavior of said chamber is corrected on the basis of experimental chartings of the profile of the temperatures prevailing in said chamber;

at least said thermodynamic and physical characteristics of said articles are used to perform a prediction of the behavior of said articles based on solving the discretized heat conservation equation applied to an array of spatial and temporal points constituting a mesh of said articles;

said prediction of the behavior of said articles furthermore uses said quantities characteristic of the operation of said installation;

said quantities characteristic of the operation of said installation comprise the temperature of said articles on entry to said chamber;

said prediction of the behavior of said articles is optimized by calculations for modifying said mesh of said articles according to mathematical series;

said prediction of the behavior of said articles is optimized by deletion of the prediction calculations for spatial and temporal points of said mesh of said articles for which the enthalpy variations are below a predetermined threshold;

said prediction of the temperature of said articles on exit from said chamber is based on said prediction of the behavior of said chamber as well as on said prediction of the behavior of said articles;

said prediction of the temperature of the articles takes into account an experimental measurement of this temperature.

A subject of the present invention is also a method of cooling articles passing from an entrance to an exit through a chamber of an installation for cooling said articles (P) which uses a cooling fluid, characterized in that it comprises a step of predicting the temperature of said articles according to the invention.

According to another characteristic of the invention, said prediction is carried out by repeating the prediction of the behavior of said chamber and the prediction of the behavior of said articles, said method comprising a step of modifying at least one of the parameters chosen from the group consisting of:

the flow rate of said cooling fluid;

the residence time of said articles in said chamber;

the flow rate of gas extracted from said chamber;

the getting up to speed of the gases;

the recirculation of the gases; and

the balance between the air inlets and the gas outlets, until a theoretical value of the temperature of said articles on exit from said chamber close to a preset is obtained.

A subject of the present invention is also a device for predicting the temperature of articles passing through an installation comprising a cooling chamber which uses a cooling fluid comprising means of prediction of this temperature, characterized in that said means of prediction comprise means of calculation which use quantities characteristic of the operation of the installation, thermodynamic and physical characteristics of said chamber and thermodynamic and physical characteristics of said articles.

A subject of the present invention is also an installation for cooling articles comprising a cooling chamber for said articles which uses a cooling fluid, characterized in that it comprises a device for predicting the temperature of said articles according to the invention.

According to other characteristics of the invention:

said cooling fluid is injected into said chamber and exchanges heat with said articles by direct contact;

said cooling fluid circulates in a heat exchange device enclosed in said chamber, and exchanges heat indirectly with said articles across said heat exchange device.

The invention will be better understood on reading the description which follows, given merely by way of example and while referring to the appended drawings, in which:

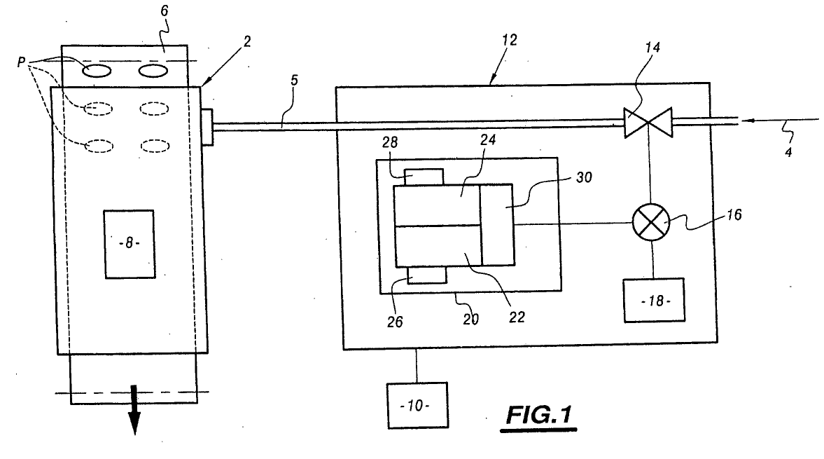

FIG. 1 represents a schematic diagram illustrating an installation implementing a method according to the invention;

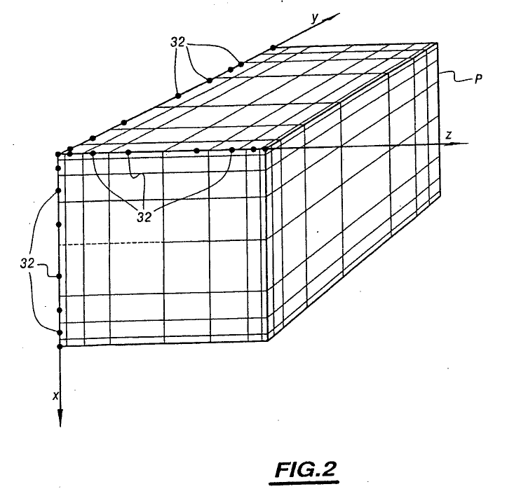

FIG. 2 illustrates the numerical modeling of the articles to be processed;

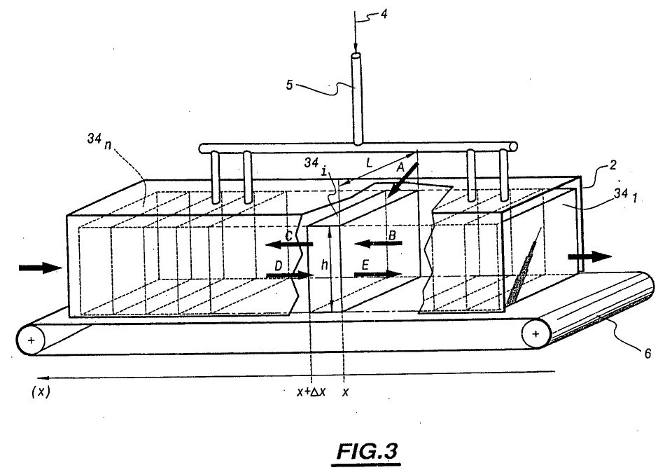

FIG. 3 illustrates the numerical modeling of the cooling chamber; and

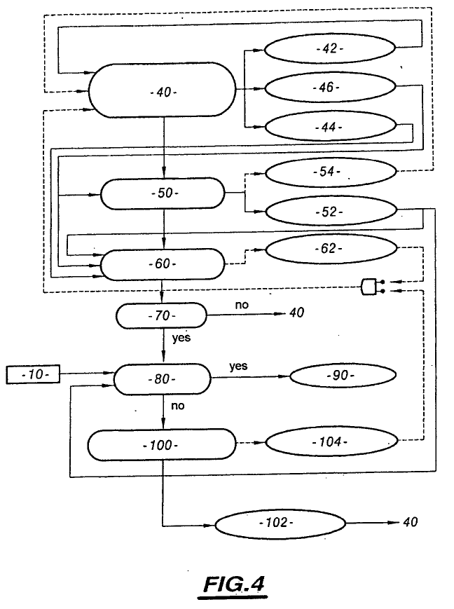

FIG. 4 represents the flowchart of the coupling of the model of the chamber and of the model of the articles.

Represented in FIG. 1 is an installation for processing food articles which is equipped to implement a method according to the invention.

This installation comprises a cryogenic tunnel or chamber 2, of conventional type, allowing the freezing of food articles P by placing them in the presence of a cryogenic fluid 4 supplied via a feed line 5, from any source whatsoever.

For example, the tunnel 2 has a right-angled parallelepipedal shape.

As stated earlier, the cryogenic fluid 4 used may for example be dry ice or liquid nitrogen.

This tunnel 2 is associated with a conveyor 6 of conventional type, allowing the articles P to be introduced into the chamber 2 and to be extracted and operating either sequentially or continuously.

The installation is equipped with means 8 for measuring characteristics relating to the installation. They deliver for example the temperature profile in the chamber 2 and the speed of travel of the conveyor 6. This latter information cue interrelated with the length of the chamber 2 makes it possible to obtain the residence time of the products P in the chamber 2.

The installation is furthermore equipped with means 10 for an operator to input operating parameters, such as for example the temperature of entry of the products P into the chamber 2.

In another version of the installation, the operating parameters cited, namely the temperature profile, the residence time or the speed of travel, and the entry temperature of the products P, are distributed differently between measurement and manual input.

The case where all the operating parameters are measured and the case where all are input manually are also possible.

The installation finally comprises means 12 for controlling the amount of cryogenic fluid 4 injected into the chamber 2.

These means 12 comprise means of regulation 14 of the flow rate of cryogenic fluid 4. For example, the means of regulation 14 consist of systems of electrovalves or proportional valves of conventional type, disposed on the cryogenic fluid 4 feed line 5.

The fluid 4 is injected at one or more locations of the chamber 2.

The regulation means 14 are controlled by the output of comparison means 16, which are linked at input to means of entry 18 of a preset concerning the temperature of the articles on exit from the chamber 2 and to means of prediction 20 of this temperature.

The regulation of the flow rate of cryogenic fluid 4 injected into an installation such as described, on the basis of a comparison between a preset and a prediction of the exit temperature of the articles, is regarded as known and will not be described in detail.

Advantageously, the installation also comprises a gas ventilation system controlling the gas streams and the ventilation of the atmosphere of the chamber 2.

For example, this system is composed of specific ventilators allowing the gases to be brought up to speed, of ventilators controlling the recirculation of the gases and of a combination between ventilators and moving gates controlling the balance between the air inlets and the gas outlets.

Within the framework of the invention, the means of prediction 20 of the temperature of the articles P on exit from the chamber 2 comprise means of prediction or predictor 22 of the behavior of the chamber 2, and means of prediction or predictor 24 of the behavior of the articles P.

The means of prediction 22 of the behavior of the chamber 2 make it possible to predict by calculation, such as is described later with reference to FIG. 3, the theoretical profile of the temperatures of the cryogenic fluid 4 inside the chamber 2.

The results delivered by the means of prediction 22 depend on thermodynamic characteristics of the cryogenic fluid 4, convective characteristics of the chamber 2, and also characteristics of the means of injection of the cryogenic fluid 4 into the chamber 2, characteristics of the ventilating system and physical characteristics of the chamber 2.

In the version described of the invention, the means of prediction 20 also comprise means of correction 26 of the predictor 22 of behavior of the chamber 2.

These means of correction 26 make it possible to take account, in the calculations of the predictor 22, of elements characteristic of the operation of the installation, such as for example the speed of the conveyor 6, chartings of temperature inside the chamber 2, the cryogenic fluid 4 temperature recovered after the processing of the articles P, or the thermal losses of the chamber 2.

The data injected into the predictor 22 by virtue of the means of correction 26 may be input manually through the means of input 10 or measured by the means of measurement 8.

For example, a bank of probes is available inside the chamber 2 which make it possible to establish an experimental profile of the temperatures of the cryogenic fluid 4 in the chamber 2.

These results are then compared with the theoretical results and the diagram of a gage curve is defined, making it possible to tailor the theoretical values delivered by the predictor 22 of the behavior of the chamber 2.

The means of prediction 24 of the behavior of the articles P make it possible to determine by calculation, such as is described later with reference to FIG. 2, the variations in enthalpy of the articles P as a function of their outside environment and of their initial temperature.

The results delivered by the predictor 24 depend on the physical and thermodynamic characteristics of the products P.

In the version described of the invention, the means of prediction 20 also comprise means of optimization 28 of the calculations of the predictor 24 of the behavior of the products P, whose manner of operation is described later with reference to FIG. 2.

Coupling means 30, described in greater detail with reference to FIG. 4, make it possible to relate the results delivered by the predictor 22 of the behavior of the chamber 2 and those delivered by the predictor 24 of the behavior of the articles P and to deliver a theoretical temperature of the articles P on exit from the chamber 2.

Thus, the prediction implemented by the means of prediction 20 of the temperature of the articles P on exit from the chamber 2 takes into account the thermodynamic and physical characteristics of the chamber 2 and of the products P, as well as the quantities characteristic of the operation of the installation.

Therefore, the determination of the temperature of the articles P on exit from the chamber 2 is dynamic, can be easily customized and can readily be made to adapt to the operating conditions of the installation.

Represented in FIG. 2 is an exemplary mesh of a food article P.

The thermodynamic and physical characteristics of the articles P are taken into account in the cooling method by the predictor 24 of the behavior of the articles P, based on a modeling of the articles P to which the discretized heat conservation equation is applied.

Specifically, the equation for the conversation of heat cannot be solved at every point in space and at every instant through a simple integral function.

The procedure employed consists in discretizing this equation so that it is now solved only on spatial and temporal points called nodes and designated by the general reference 32.

After defining a mesh of the article P, the heat conservation equation is applied to each of the nodes 32.

An equation system is thus obtained that must be solved in order to ascertain the thermal state of the article P over time and in space.

$$\frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) = ρ \frac{\partial ( C . T )}{\partial t}$$

X, Y and Z are axes defining an orthonormal spatial frame of reference around the article P. T is the temperature of the article P expressed in Kelvin (K), and C its specific heat expressed in watts per kilogram and per Kelvin (W/(Kg*K)).

The food articles P that are quick-frozen generally consist of different substances.

This implies that change of phase is accompanied by a temperature variation and that the heat conservation equation can always be applied.

On the other hand, when forced to deal with a pure substance, the equation is no longer continuous. In this case, the problem is simplified by modifying the enthalpy table of the pure substance so that change of size gives rise to a small temperature variation.

The discretization is achieved by virtue of the mathematical procedure of finite differences in a variable regime.

In a known manner, the latter may be performed in two ways.

The first, implicit discretization, has the advantage of being stable whatever the spatial and temporal configuration. At a given instant, it makes it possible to determine the temperature of a node 32 as a function of the temperature of the neighboring nodes at the same instant. However, it involves constant boundary conditions and matrix solution of the equation system formed by each of the nodes 32.

The second, explicit discretization, makes it possible to directly determine the temperature of a node 32 at an instant T+ΔT according to the conditions at the instant T. The result is immediate, on the other hand, a timestep suitable for avoiding the instability of the model must be chosen.

The first procedure is recommended in the case where one seeks to obtain chiefly the surface temperature of a product, this corresponding to the operation commonly referred to as the “crust freezing” operation. The second is recommended when one wishes to quick freeze and ascertain the core temperature of a product.

The meshing of the product P is a crucial problem. It directly determines the simplicity of the subsequent processing and the accuracy of the results.

A significant number of nodes brings high accuracy in the result but imposes a considerable calculation time. A compromise has to be found between accuracy and calculation time.

For example, for the case of a food product of outside dimensions 100×60×10 mm with a regular mesh every millimeter, more than 17 000 nodes and as many equations are required in order to define the behavior of the article P.

In the version described of the invention, means of optimization 28 of the calculations are available, these making it possible to optimize the meshing which is performed in the predictor 24 of the behavior of the articles P.

For example, in the case of crust freezing, the solidification of a slender thickness of the skin of the product is more particularly monitored by change of phase. Hence, a mesh which is dense at the periphery and wider at the core is necessary.

So as not to manually input the coordinates of each of the nodes and so as to keep simple relations between the nodes and ease the processing, a solution consists in distributing nodes in each direction in space with the aid for example of a geometric progression, as is represented in FIG. 2.

For example, on the X axis, the nodes are distributed in the following manner: let Δx be the value of the first term which corresponds to the abscissa of the first node, and let r be the common ratio, different from 1, of the geometric series implemented. The value of the n^{th} term is: Δx*rⁿ⁻¹, this corresponding to the position on the X axis of the n^{th} node. The sum of the first n terms is:

$$s = Δ x + \frac{1 {r}^{n}}{1 r}$$

FIG. 2 represents the positioning of the nodes according to this mesh on a parallelepipedal article P where a parity condition has been imposed on the number of nodes so as to simplify the solution procedure.

A value corresponding to the dimension of the article P along the X axis is thus obtained:

$${L}_{p} = Δ x + Δ x ( 1 + r ) \frac{1 - {r}^{1}}{1 - r} = Δ x ( 1 + \frac{1}{R} ( 1 - {r}^{1} ) )$$

$$with R = \frac{1 - r}{1 + r}$$

With l which corresponds to the abscissa of the central node over this length:

$$1 = \frac{Ln ( 1 - ( \frac{{L}_{p}}{Δ x} - 1 ) R )}{Ln ( r )}$$

The inaccuracy with regard to the X axis is then expressed in the following manner:

$$- 1 / 2 \leq 1 - \frac{Ln ( 1 - ( \frac{{L}_{p}}{Δ x} - 1 ) R )}{Ln ( r )} < 1 / 2 ⇔ {L}_{p} - \frac{Δ x}{R} {r}^{1} ( {r}^{\frac{- 1}{2}} - 1 ) \leq Δ x ( 1 + \frac{1}{R} ( 1 - {r}^{1} ) ) < {L}_{p} + \frac{Δ x}{R} {r}^{1} ( {r}^{\frac{1}{2}} - 1 )$$

In order for the calculations to be simple, the inaccuracies in the three axes are fixed at one and the same value. This induces an error with regard to the dimensions of the article P which is acceptable in the case where one is interested only in the temperatures over a small skin thickness and the core temperatures vary little, as is the case in crust-freezing operations.

In the case of quick-freezing operations where one seeks to determine the core temperature of the product, a corrective term can be inserted into the formulae. In the case of the X axis, the following corrective term is inserted:

$$Δ x = \frac{{L}_{p}}{1 + \frac{1}{R} ( 1 {r}^{1} )}$$

Another possible optimization procedure consists in reducing the processing time by omitting certain calculations.

Specifically, on each node, the thermal flux at the six faces of its elementary volume are added together. However, zones exist where the thermal effects are akin to one-dimensional problems.

To exploit this feature, the processing is broken down by summing the thermal fluxes over each face in each direction, rather than globally. In each direction, the equations at the nodes are solved, for a timestep ΔT, by marching from the boundary toward the core, until the enthalpy variation is considered to be negligible on account of being below a predetermined threshold.

By performing this operation in each direction, a volume of the product P is defined which encompasses all the nodes for which the enthalpy variations are negligible, and hence for which no calculation will be done.

Calculation time can thus be saved, especially in the first few instants of exchange.

In the case where the article P is of complex shape, it can be broken down into a set of elementary shapes to which the mesh defined above or any other mesh suited to the shape of the article P can be applied.

The means of prediction 24 of the behavior of the articles P and the means of optimization 28 of the calculations are, for example, implemented by software means.

Represented diagrammatically in FIG. 3 is the chamber for processing the food articles.

The thermodynamic and physical characteristics of the chamber 2 are taken into account, in the cooling method, by the predictor 22 of the behavior of the chamber 2, based on a modeling of the chamber 2 in the form of elementary slices.

As described previously with reference to FIG. 1, the cooling chamber 2 is associated with a conveyor 6. It is fed with cryogenic fluid 4 via a feed line 5. The chamber 2 is akin to a right-angled parallelepiped.

To determine the theoretical profile of the temperatures of the fluid 4, the procedure implemented by the predictor 22 of the behavior of the chamber 2 consists in performing a succession of local thermal balances.

For this purpose, a modeling of the thermodynamic system of the tunnel 2, in the steady state, is considered in the form of elementary slices 34₁ to 34ₙ, perpendicular to the length of the chamber 2. The sum of these elementary slices 34₁ to 34ₙ represents the internal volume of the chamber 2.

For each elementary slice 34₁ to 34ₙ, the balance of the heat transfers is computed, so as to determine the enthalpy of the fluid 4 and hence its temperature.

This balance must take into account:

heat escapes with the exterior of the tunnel 2;

the cryogenic liquid 4 injected into the spraying zones; and

exchanges between the products P and the fluid 4.

In the case of the slice 34ᵢ of the tunnel of dimensions L*l*h, the heat balance is represented by the following equation:

$${H}_{fs ( i )} = {H}_{fe ( i )} + \frac{\begin{matrix}2 {K}_{T} ( 1 + h ) ( {T}_{Amb} - {T}_{fe ( i )} ) Δ x - \\ Δ {\dot{m}}_{fSpray ( i )} * ( {H}_{fe ( i )} - {H}_{fLiq} ) + {\dot{m}}_{p} ( {H}_{pe ( i )} - {H}_{ps ( i )} )\end{matrix}}{{\dot{m}}_{fe ( i )} + Δ {\dot{m}}_{fSpray ( i )}}$$

In this equation:

H_{fs(i)} corresponds to the enthalpy of the cryogenic fluid 4 on exit from the elementary slice 34ᵢ, expressed in joules per kilogram (J/Kg);

H_{fe(i)} corresponds to the enthalpy of the cryogenic fluid 4 on entry to the elementary slice 34i, expressed in joules per kilogram (J/Kg);

H_{fLiq} corresponds to the liquid enthalpy of the cryogenic fluid 4 injected, expressed in joules per kilogram (J/Kg);

Hₚₑ₍ᵢ₎ corresponds to the enthalpy of the article P on entry to the slice 34ᵢ expressed in joules per kilogram (J/Kg);

Hₚₛ₍ᵢ₎ corresponds to the enthalpy of the article P on exit from the slice 34ᵢ expressed in joules per kilogram (J/Kg);

K_{T} corresponds to the coefficient of heat exchange of the tunnel 2 with the exterior expressed in watts per square meter and per Kelvin (W/(m²K));

\dot{m}_{fSpray(i)} corresponds to the mass flow rate of cryogenic fluid 4 evaporated in the slice 34ᵢ, expressed in kilograms per second (Kg/s);

\dot{m}_{fe(i)} corresponds to the mass flow rate of cryogenic fluid 4 entering the slice 34ᵢ, expressed in kilograms per second (Kg/s);

\dot{m}ₚ corresponds to the mass flow rate of products to be processed, expressed in kilograms per second (Kg/s);

T_{Amb} corresponds to the ambient temperature expressed in Kelvin; and

T_{fe(i)} corresponds to the temperature of the cryogenic fluid 4 on entry to the slice 34ᵢ expressed in Kelvin.

Also represented in FIG. 3 are the heat fluxes:

\dot{m}_{fSpray(i)}H_{fLiq} is represented by the letter A;

\dot{m}_{fe(i)}H_{fe(i)} is represented by the letter B;

\dot{m}_{fs(i)}H_{fs(i)} is represented by the letter C;

\dot{m}ₚHₚₑ₍ᵢ₎ is represented by the letter D; and

\dot{m}ₚHₚₛ₍ᵢ₎ is represented by the letter E;

with \dot{m}_{fs(i)}=\dot{m}_{fe(i)}+Δ\dot{m}_{fSpray(i)}

By experiment, it is known that under certain operating conditions (production rate too small or temperature of the cryogenic fluid 4 too low), the cryogenic liquid 4 injected is only partially evaporated and a fraction of the liquid flows toward the entrance of the chamber 2.

If one wishes to take this phenomenon into account, it is preferable to solve the local balances beginning with the elementary slice situated at the exit of the tunnel. The calculations are then done in the reverse direction to the travel of the products P along the X axis as represented in FIG. 3.

In fact in this direction, the fraction of unevaporated liquid can be referred to the next fraction and so on and so forth until the ventilation zones are reached where the flow rates injected are zero and where the liquid surpluses are evaporated.

To determine the fraction of unevaporated cryogenic liquid 4 in an elementary slice, we designate a limit fluid enthalpy, below which a liquid titer will appear.

This is equivalent to fixing a minimum gaseous fluid temperature in the tunnel.

The unevaporated liquid titer exiting the elementary slice 34ᵢ corresponds to X_{L(i)} and is expressed in the following form:

$${X}_{L ( i )} = \frac{{\dot{m}}_{fLiq ( i )}}{{\dot{m}}_{fs ( i )}}$$

If the calculations are simplified by considering the enthalpy of this liquid fraction to be substantially equal to the enthalpy of the cryogenic fluid 4 injected, the following expression for the titer of the liquid is obtained:

$${X}_{L} = \frac{( {H}_{fLim} - {H}_{fs} )}{( {H}_{fLim} - {H}_{fLiq} )}$$

In this equation, H_{fLim} corresponds to the limit enthalpy of formation of a liquid titer in an elementary slice of the tunnel 2.

Represented in FIG. 4 is the manner of operation of the means 20 of prediction of the temperature of the articles P on exit from the chamber 2.

In order to be able to make a prediction of the temperature of the articles P on exit from the chamber 2, the cooling method involves the prediction of the behavior of the chamber 2 as implemented by the predictor 22 of the behavior of the chamber 2 and the prediction of the behavior of the articles as implemented by the predictor 24 of the behavior of the articles P.

In the installation described with reference to FIG. 1, this step is implemented by the coupling means 30.

We begin by implementing the predictor 22 of the behavior of the chamber 2, during a step 40.

This delivers the heat losses 42 per elementary slice which are reintroduced into the predictor 22.

After repeating this operation a certain number of times, the total heat losses 44 are obtained, as is the profile 46 of the temperatures of the fluid 4 in the chamber 2.

To calculate the heat balance of each slice, the predictor 22 requires the enthalpy variations of the articles P. In fact, during the first iteration, since the profile of the temperatures of the fluid 4 in the chamber 2 cannot be calculated, it is fixed arbitrarily.

We then implement the predictor 24 of the behavior of the articles P, during a step 50. This delivers the enthalpy 52 of the product P on exit from the chamber 2, i.e. its temperature.

Optionally, the predictor 24 of the behavior of the articles P also delivers the enthalpic variations 54 of an article P for each elementary slice of the chamber 2. In this case, this information is returned to the predictor 22 of behavior of the chamber 2 which inserts it into the heat balance for each elementary slice.

The enthalpy 52 of the product P on exit from the chamber 2 as well as the profile 46 of the temperatures of the fluid 4 in the chamber 2 and the total heat losses 44 are interrelated so as to determine the total flow rate of the fluid, in step 60.

Optionally, the flow rate 62 injected into each elementary slice is also obtained. In this case, this information is returned to the predictor 22 of behavior of the chamber 2 which inserts it into the heat balance for each elementary slice.

We then check whether the profile of the temperatures of the fluid 4 in the chamber 2 is stable, in step 80.

For example, the profile of the temperatures of the fluid is regarded as stable if it satisfies the following criteria twice in succession:

$$\frac{{H}_{p s ( 1 , k )} - {H}_{p s ( 1 , k - 1 )}}{{H}_{p s ( 1 , k )}} \leq dif\_profile$$

In this equation, dif_profile is a constant fixed by the operator.

In the first pass, the profile is regarded as unstable.

As long as the profile is regarded as unstable, we return to step 40 and we repeat the succession of operations whereby a profile can be defined.

Once a stable profile has been obtained, we check whether the preset input via the means 10 of entry of a preset pertaining to the temperature of the products P on exit from the chamber 2 has been reached, in step 80.

If the preset has been reached, the last profile of the temperatures of the fluid 4 inside the chamber 2 is implemented, in a conventional manner, by control of the means 14 of regulation of the flow rate of fluid 4, in step 90.

If the preset has not been reached, in step 100, a correction 102 is applied to the flow rate of the fluid 4 before repeating the algorithm. Optionally, a correction 104 is also applied directly to the profile of the temperatures of the fluid 4 and is injected into the predictor 22 of the behavior of the chamber 2.

In this example, the prediction of the temperature of the articles on exit from the chamber is used to perform automated running of a cryogenic chamber 2 by influencing the flow rate of the fluid 4 injected.

The residence time of the articles P in the chamber 2 can be influenced in the same way by modifying the speed of the conveyor 6 or the stoppage times in the case of a sequential conveyor. It is also possible to alter the rate of extraction of the gases or the degree of loading, or a combination of these parameters.

Likewise, it is possible to influence the balance between the air inlets and the gas outlets, the rate of extraction of the gases, the bringing up to speed of the gases, or else the recirculation of the gases by influencing the elements for controlling these parameters.

It is conceivable for the algorithm to be constantly repeated so as to ensure the continuous monitoring of the operating conditions and allow the tailoring of the profile of the temperatures of the fluid.

It is also conceivable to implement the algorithm following the detection of a modification of the operating parameters.

Moreover, the method of the invention is implemented in an installation having contactless sensors of the temperature of the articles on exit, for example sensors based on thermal radiation or an infrared image, or else on a measurement by microwave thermometry (MWT), such as the sensor described in patent FR-A-2 771 552.

The results delivered by the means of prediction of the temperature of the articles on exit from the chamber according to the invention are then cross-checked against the measurements delivered by these sensors.

In this case, one or other of the information cues is used to verify the other, or an average of the two values is used to run the installation.

In another situation, the information cue delivered by the sensor is used to correct the prediction. Advantageously, the measurement frequency is less than the frequency of delivery of a prediction.

Although a particular embodiment has been described, it is not regarded as limitative of the scope of the present invention.

In another version, the installation is equipped with means of determination of the value representative of the quality and/or quantity of articles processed, which means are linked to the means of prediction of the temperature of the articles on exit according to the invention.

Moreover, the method of cooling of the invention can also be applied in a mechanical cold installation having an indirect heat exchange device.

The invention has been described in the case of the cooling of food articles, however it can also be applied to other types of articles, in particular metal ones.

Moreover, the term cooling also covers systems aimed at maintaining and controlling a temperature below the initial temperature of an article.

Furthermore, the invention is described within the framework of a cooling installation. However, the temperature prediction method can be implemented independently of the means of regulation of the chamber for example within the framework of the control of the temperature.

The invention makes it possible in particular to guarantee the traceability of articles during acquisition and storage operations with a view to offering quality assurance.

1-34. (canceled).

35: A method of predicting exit temperature of articles, comprising:
a) introducing articles to be cooled into a cooling chamber;
b) introducing a cooling fluid into said cooling chamber;
c) predicting the temperature of said articles on exit from said cooling chamber utilizing a first criteria set, said first criteria set comprising characteristics of the operation of said chamber;
d) predicting the temperature of said articles as they exit said cooling chamber utilizing a second criteria set, said second criteria set comprising thermodynamic and physical characteristics of said chamber; and
e) predicting the temperature of said articles as they exit said cooling chamber based on a third criteria set, said third criteria set comprising thermodynamic and physical characteristics of said articles.

36: The method as claimed in claim 35, wherein at least part of said first criteria set is input manually.

37: The method as claimed in claim 35, wherein at least part of said first criteria set is charted automatically.

38: The method as claimed in claim 35, wherein at least thermodynamic characteristics of said cooling fluid and said second criteria set are used to perform a prediction of the behavior of said chamber based on the solving of heat balances on elementary slices of the volume of said chamber.

39: The method as claimed in claim 38, wherein said prediction of the behavior of said chamber furthermore uses said first criteria set.

40: The method as claimed in claim 39 wherein said first criteria set represent at least one of the members selected from the group consisting of:
a) the speed of a conveyor for transporting said articles through said cooling chamber;
b) the degree of loading; and
c) the ventilation of the atmosphere of said chamber.

41: The method as claimed in claim 38, wherein said prediction of the behavior of said chamber is corrected on the basis of experimental chartings of the profile of the temperatures prevailing in said chamber.

42: The method as claimed in claim 38, wherein at least said third criteria set are used to perform a prediction of the behavior of said articles based on solving the heat conservation equation applied to an array of spatial and temporal points constituting a mesh of said articles.

43: The method as claimed in claim 42, wherein said prediction of the behavior of said articles further comprises said first criteria set.

44: The method as claimed in claim 43, wherein said first criteria set comprises the temperature of said articles on entry to said chamber.

45: The method as claimed in claim 42, wherein said prediction of the behavior of said articles is optimized by calculations for modifying said mesh of said articles according to mathematical series.

46: The method as claimed in claim 42, wherein said prediction of the behavior of said articles is optimized by deletion of the prediction calculations for spatial and temporal points of said mesh of said articles for which the enthalpy variations are below a predetermined threshold.

47: The method as claimed in claim 42, wherein said prediction of the temperature of said articles on exit from said chamber is based on said prediction of the behavior of said chamber and on said prediction of the behavior of said articles.

48: The method as claimed in claim 35, wherein said prediction of the temperature of the articles takes into account an experimental measurement of this temperature.

49: A method of cooling articles, comprising:
a) passing articles to be cooled through an entrance, into a cooling chamber;
b) predicting the temperature of said articles as they exit said chamber, comprising:
i) introducing articles to be cooled into a cooling chamber;
ii) introducing a cooling fluid into said cooling chamber;
iii) predicting the temperature of said articles on exit from said cooling chamber utilizing a first criteria set, said first criteria set comprising characteristics of the operation of said chamber;
iv) predicting the temperature of said articles as they exit said cooling chamber utilizing a second criteria set, said second criteria set comprising thermodynamic and physical characteristics of said chamber; and
v) predicting the temperature of said articles as they exit said cooling chamber based on a third criteria set, said third criteria set comprising thermodynamic and physical characteristics of said articles;
c) providing a cooling fluid in said cooling chamber;
d) cooling said articles; and
e) passing said articles through an exit, out of said cooling chamber.

50: The method as claimed in claim 49, wherein said prediction is carried out by repeating a prediction of the behavior of said chamber and a prediction of the behavior of said articles, said method comprising a step of modifying at least one of the members selected from the group consisting of:
a) the flow rate of said cooling fluid;
b) the residence time of said articles in said chamber;
c) the flow rate of gas extracted from said chamber;
d) the getting up to speed of the gases;
e) the recirculation of the gases; and
f) the balance between the air inlets and the gas outlets, until a theoretical value of the temperature of said articles on exit from said chamber close to a preset is obtained.

51: A device for predicting the temperature of articles passing through an installation comprising:
a) a cooling chamber which uses a cooling fluid;
b) means of predicting temperature;
c) said means of prediction comprise means of calculation which use a first criteria set, said first criteria set comprising characteristics of the operation of said installation;
d) said means of prediction comprise means of calculation which use a second criteria set, said second criteria set comprising thermodynamic and physical characteristics of said chamber; and
e) said means of prediction comprise means of calculation which use a third criteria set, said third criteria set comprising thermodynamic and physical characteristics of said articles.

52: The device as claimed in claim 51, wherein at least part of said first criteria set has means of manual entry.

53: The device as claimed in claim 51, wherein at least part of first criteria set has means of measurement.

54: The device as claimed in claim 51, wherein said means of prediction comprise a chamber predictor suitable for predicting the behavior of said chamber on the basis of solving thermal balances on elementary slices of the volume of said chamber, said chamber predictor receiving as input, thermodynamic characteristics of said cooling fluid and second criteria set.

55: The device as claimed in claim 54, wherein said chamber predictor furthermore receives as input, said first criteria set.

56: The device as claimed in claim 55, wherein said first criteria set represent at least one of the members selected from the group consisting of the speed of a conveyor for transporting said articles through said chamber, the degree of loading, and the ventilation of the atmosphere of said chamber.

57: The device as claimed in claim 54, wherein said chamber predictor is associated with correction means based on experimental chartings of the profile of the temperatures prevailing in said chamber.

58: The device as claimed in claim 54, wherein said means of prediction comprise an articles predictor suitable for predicting the behavior of said articles on the basis of the solving of the heat conservation equation applied to an array of spatial and temporal points constituting a mesh of said articles, said articles predictor receives as input at least said third criteria set.

59: The device as claimed in claim 58, wherein said articles predictor furthermore receives as input, said first criteria set.

60: The device as claimed in claim 59, wherein said first criteria set comprise the temperature of said articles on entry to said chamber.

61: The device as claimed in claim 58, wherein said articles predictor is associated with means of optimization of the calculations by modifying said mesh of said articles according to mathematical series.

62: The device as claimed in claim 58, wherein said articles predictor is associated with means of optimization of calculation by deletion of the prediction calculations for spatial and temporal points of said mesh of said articles for which the enthalpy variations are below a predetermined threshold.

63: The device as claimed in claim 58, wherein said means of prediction comprises means of coupling of said chamber predictor and said articles predictor.

64: An installation for cooling articles comprising a cooling chamber for said articles which uses a cooling fluid, said cooling chamber comprising a device for predicting the temperature of said articles according to claim 51.

65: The installation as claimed in claim 64, further comprising a means of coupling which carry out a repetition of the implementation of the chamber predictor and of the implementation of the articles predictor and means of comparison which are linked at input to means of entry of a temperature preset for said articles on exit from said chamber and to said means of prediction, and are linked at output to control means comprising regulation means suitable for modifying at least one of the members selected from the group consisting of:
a) the flow rate of said cooling fluid;
b) the residence time of said articles in said chamber;
c) the flow rate of gas extracted from said chamber;
d) the getting up to speed of the gases;
e) the recirculation of the gases; and
f) the balance between the air inlets and the gas outlets, until a theoretical value of the temperature of said articles on exit from said chamber close to the preset input by virtue of said means of input of a temperature preset is obtained.

66: The installation as claimed in claim 64, wherein said cooling fluid is injected into said chamber and exchanges heat with said articles by direct contact.

67: The installation as claimed claim 64, wherein said cooling fluid circulates in a heat exchange device enclosed in said chamber, and exchanges heat indirectly with said articles across said heat exchange device.

68: The installation as claimed in claim 64, further comprising means for measuring the temperature of said articles on exit from said chamber which deliver an information cue taken into account by the means of prediction.
